(19) United States
(12) Patent Application Publication
(10) Pub. No.: US 2023/0352922 A1
(43) Pub. Date: Nov. 2, 2023

(54) DEVICES AND METHODS FOR INSTALLATION DEVICE CUSTOMIZATION

(71) Applicant: ABB Schweiz AG, Baden (CH)

(72) Inventor: Michael Devin O'Neil, Memphis, TN (US)

(21) Appl. No.: 17/661,028

(22) Filed: Apr. 27, 2022

(51) Int. Cl. H02G 3/08; H02G 3/18; B05D 7/00; B05D 5/06

(52) U.S. Cl. CPC H02G 3/081; H02G 3/185; B05D 7/576; B05D 5/06

(57) ABSTRACT

An installation device can include a body having a substrate, a first coating, and a second coating. The first coating can include a tinted coating. The second coating can include a clear coat sealant. The first coating and the second coating coat at least part of the substrate, the first coating located between the substrate and the second coating. Further, each of the first coating and the second coating can include a polyceramic compound. The installation device can further include a third coating and a fourth coating. The third coating can be a primer coating and the fourth coating can be a hydrographic film. The body can further include a recessed segment located on the first side, at least one opening extending through the body, and a cover plate to cover, at least in part, the at least one opening and the recessed segment.

### FIELD

The present disclosure relates to the field of electronics, and more specifically, to electric floor box covers.

### BACKGROUND

Installation devices for electrical components cover and protect the electrical components and prevent the intrusion of dirt or debris, protect the components from damage, and can prevent accidental contact with live electrical components. Installation devices typically include either a raw finish or a powder coated surface. Raw finishes are typically susceptible to scratches, scuffs, and abrasions. Alternatively, although powder coatings can provide improved protection from damage, options for powder coated components are limited to single colors. Consequently, improved installation devices may be desirable that provide durability and resistance to damage while providing broader trim options.

### SUMMARY

In some embodiments, an installation device includes a body including a proximal end and a distal end, a first coating, wherein the first coating includes a tinted coating; and a second coating; wherein the second coating includes a clear coat sealant; wherein the device includes a substrate having a surface; wherein the first coating and the second coating coat at least part of the substrate; wherein the first coating includes being disposed between the substrate and the second coating.

In some embodiments, each of the first coating and the second coating further includes a polyceramic coating.

In some embodiments, the installation device further includes: a third coating, wherein the third coating includes a primer coating disposed between the substrate and the first coating; wherein the first coating further includes a base coating disposed between the second coating and the third coating.

In some embodiments, the installation device further includes: a fourth coating, wherein the fourth coating includes a graphic pattern disposed between the first coating and the second coating, wherein the first coating can be at least partially observed through a portion of the fourth coating.

In some embodiments, the fourth coating further includes a PVA hydrographic film applied using water transfer printing.

In some embodiments, the body further includes: a first member disposed at the proximal end, the first member including: a first side disposed at the proximal end, a second side disposed opposite the first end towards the distal end, a third side defining a circumference and axially extending from the first side to the second side, and at least one opening axially extending through the first member from the first side to the second side.

In some embodiments, the installation device further includes a cover plate; wherein the first member further includes a recessed segment disposed on the first side and axially extending towards the distal end; wherein the at least one opening further includes being disposed at the recessed segment; wherein the cover plate includes being disposed at the recessed segment and the cover plate covers, at least in part, the at least one opening.

In some embodiments, the installation device receives a preparation prior to being coated, wherein the preparation includes sanding the surface of the substrate.

In some embodiments, the installation device receives a pretreatment prior to being coated, wherein the pretreatment includes the surface of the substrate receiving a chemical wash, a flame treatment, a corona treatment, and a combination thereof.

In some embodiments, a method for coating an installation device, the installation device including a body and having a proximal end and a distal end, the body including a substrate, the method including: applying, to the installation device, a first coating; and applying, to the installation device, a second coating;

wherein the first coating includes a colored coating; wherein the second coating includes a clear coat sealant; wherein the first coating and the second coating cover at least a portion of the substrate; wherein the first coating includes being disposed between the substrate and the second coating.

In some embodiments, the method further includes applying, to the installation device, a third coating; wherein the third coating includes a primer coating disposed between the substrate and the first coating applied to a raw surface of the substrate.

In some embodiments, the method further includes applying, to the installation device, a fourth coating, wherein the fourth coating includes a graphic disposed between the first coating and the second coating. wherein the first coating can be at least partially observed through a portion of the fourth coating.

In some embodiments, the fourth coating further includes a PVA hydrographic film applied using water transfer printing.

In some embodiments, the installation device further includes a cover plate, and wherein the body further includes: a recessed segment disposed on the body at the proximal end, at least one opening extend through the body from the proximal end to the distal end, wherein the cover plate includes being disposed on the proximal end of the body at the recessed segment to cover, at least in part, the at least one opening.

In some embodiments, the method further includes preparing the substrate to receive a coating, wherein preparing the substrate includes sanding a surface of the substrate; pre-treating the substrate to receive a coating, wherein pre-treating the substrate includes a chemical wash, a flame treatment, a corona treatment, and any combination thereof.

In some embodiments, a cover apparatus includes a body, the body including: a substrate defining the body and including a surface; a first side, a second side, a third side extending from the first side to the second side, at least one opening extending from the first side to the second side, at least one aperture extending from the first side to the second side; at least one layer of first coating, wherein the at least one layer of first coating includes a tinted base coating; at least one layer of second coating, wherein the at least one layer of second coating includes a clear coat sealant; wherein the at least one layer of first coating includes being disposed between the substrate and the at least one layer of second coating; wherein the at least one aperture can receive a connector to connect the cover apparatus to an electrical box.

In some embodiments, the at least one first coating further includes a polyceramic base coating.

In some embodiments, the second coating includes a polyceramic clear coat sealant.

In some embodiments, the cover apparatus further includes at least one layer of third coating, wherein the at least one layer of third coating includes a primer coating, wherein the at least one layer of third coating includes being disposed between the substrate and the at least one layer of first coating; at least one layer of fourth coating, wherein the at least one layer of fourth coating includes a water transfer graphic, wherein the at least one layer of fourth coating includes being disposed between the at least one layer of first coating and the at least one layer of second coating.

In some embodiments, the cover apparatus further includes a cover plate;

wherein the body further includes: a recessed segment disposed on the first side and extending from the first side towards the second side; wherein the at least one opening includes being disposed in the recessed segment; wherein the cover plate includes being disposed at the recessed segment to cover, at least in part, the recessed segment and the at least one opening.

### DRAWINGS

Some embodiments of the disclosure are herein described, by way of example only, with reference to the accompanying drawings. With specific reference now to the drawings in detail, it is stressed that the embodiments shown are by way of example and for purposes of illustrative discussion of embodiments of the disclosure. In this regard, the description taken with the drawings makes apparent to those skilled in the art how embodiments of the disclosure may be practiced.

FIG. 1 is a perspective view of an installation device, according to some embodiments.

FIG. 2 is a perspective view of the installation device, according to some embodiments.

FIG. 3 is a perspective view of the installation device, according to some embodiments.

FIG. 4 is a perspective view of the installation device, according to some embodiments.

FIG. 5 is a bottom perspective view of the installation device, according to some embodiments.

FIG. 6 is a side view of the installation device, according to some embodiments.

FIG. 7 is a flowchart of a method, according to some embodiments.

FIG. 8 is a flowchart of the method, according to some embodiments.

FIG. 9 is a flowchart of the method, according to some embodiments.

FIG. 10 is a flowchart of the method, according to some embodiments.

### DETAILED DESCRIPTION

Among those benefits and improvements that have been disclosed, other objects and advantages of this disclosure will become apparent from the following description taken in conjunction with the accompanying figures. Detailed embodiments of the present disclosure are disclosed herein; however, it is to be understood that the disclosed embodiments are merely illustrative of the disclosure that may be embodied in various forms. In addition, each of the examples given regarding the various embodiments of the disclosure which are intended to be illustrative, and not restrictive.

All prior patents and publications referenced herein are incorporated by reference in their entireties.

Throughout the specification and claims, the following terms take the meanings explicitly associated herein, unless the context clearly dictates otherwise. The phrases “in one embodiment,” “in an embodiment,” and “in some embodiments” as used herein do not necessarily refer to the same embodiment(s), though it may.

Furthermore, the phrases “in another embodiment” and “in some other embodiments” as used herein do not necessarily refer to a different embodiment, although it may. All embodiments of the disclosure are intended to be combinable without departing from the scope or spirit of the disclosure.

As used herein, the term “based on” is not exclusive and allows for being based on additional factors not described, unless the context clearly dictates otherwise. In addition, throughout the specification, the meaning of “a,” “an,” and “the” include plural references. The meaning of “in” includes “in” and “on.”

As used herein, the term “between” does not necessarily require being disposed directly next to other elements. Generally, this term means a configuration where something is sandwiched by two or more other things. At the same time, the term “between” can describe something that is directly next to two opposing things. Accordingly, in any one or more of the embodiments disclosed herein, a particular structural component being disposed between two other structural elements can be:
disposed directly between both of the two other structural elements such that the particular structural component is in direct contact with both of the two other structural elements;
disposed directly next to only one of the two other structural elements such that the particular structural component is in direct contact with only one of the two other structural elements;
disposed indirectly next to only one of the two other structural elements such that the particular structural component is not in direct contact with only one of the two other structural elements, and there is another element which juxtaposes the particular structural component and the one of the two other structural elements;
disposed indirectly between both of the two other structural elements such that the particular structural component is not in direct contact with both of the two other structural elements, and other features can be disposed therebetween; or
any combination(s) thereof.

As used herein, “coating” means a layer, or a plurality of layers, of a coating material that can be applied to an object or the surface of an object. The coating can include a liquid coating composed of acrylics, enamels, latex, acrylic enamels, epoxy, urethanes, polyurethanes, lacquers, ceramics, thinners, acids, other compounds, and any combination thereof. The coating can include a film for transcription of a graphic pattern onto the object or the surface of the objection. The coating can include a hydrographic film that can be applied using water transfer printing. The coating can include polyvinyl acetate (PVA), activators, other films, other compounds, and any combination thereof. The graphic pattern can include a single layer or a plurality of layers that compose the graphic pattern.

As used herein, the term “cover” means an object having a body that can cover an opening of a structural surface. The cover can also attach to a floor box located at, near, or through the opening of the structural surface. The cover can be detachably attached to the floor box by any of a plurality of connectors. The cover can be positioned, at least in part, onto the structural surface at the opening to cover the opening, any electrical components, other components, and any combination thereof.

As used herein, the term “structural surface” means a floor, wall, ceiling, other structural surface, and any combination thereof. The structural surface can be composed of wood, ceramic, metal, polymer, composites, polyvinyl, marble, granite, concrete, other materials, and any combination thereof. The structural surface can include an opening where electrical components, or the installation device, can, at least in part, extend through.

As used herein, the term “electrical box” means a housing that forms a receptacle and having at least one opening extending through a surface of the housing. The electrical box can include a floor box. Further, components including electrical wiring, conductors, connectors, retaining members, other components, and any combination thereof, can be located in the electrical box. Further, the electrical box can be attached to a structural member or the electrical box can be attached to a mounting member, and the mounting member can attach the electrical box to the structural member. The electrical box can further include any of a plurality of components to connect the installation device to the electrical box to retain the installation device at the opening of the structural surface.

As used herein, the term “automotive grade” means a liquid coating delivered onto a substrate, or the surface of the substrate, using a plurality of means including, but not limited to, a spray gun. The paint can cure, or dry, by solvent evaporation, or can include a catalyzed paint. The object receiving the paint can also have a voltage applied to the object, and act as a cathode with the paint acting as an anode sticking to the surface of the object. The coating can further include tints or colorants to color the coating.

While the invention is susceptible to various modifications and alternative forms, specific embodiments thereof are shown by way of example in the drawings as a cover plate. It should be understood, however, that the drawings and detailed descriptions thereto are not intended to limit the invention to the particular form disclosed, but on the contrary, the intention is to cover all modifications, equivalents, and alternative forms falling within the spirit and scope of the present invention as defined by the claims.

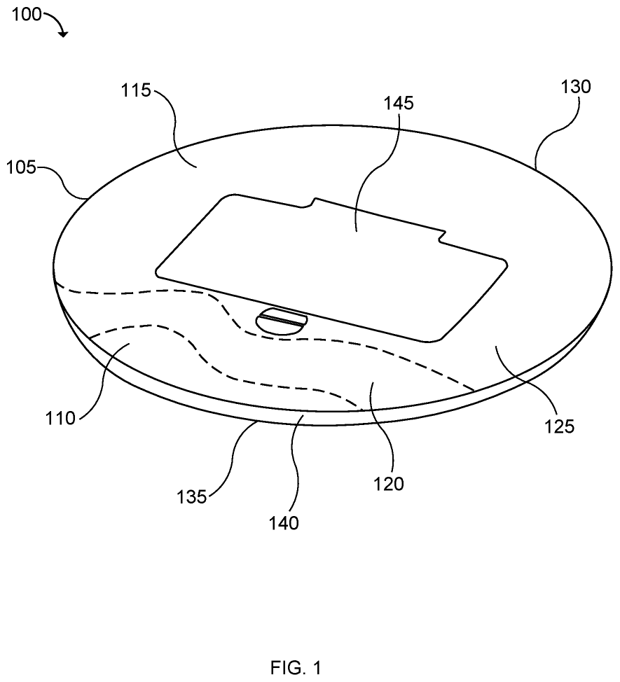

FIG. 1 is a perspective view of an installation device 100, according to some embodiments. The installation device 100 can include a body 105, a first coating 120, and a second coating 125. The body 105 can include a proximal end and a distal end. Further, a surface of the body 105 can include a substrate 110.

The installation device 100 can include any of a plurality of electrical components, members that house electrical components, members that connect or attach to electrical components, other members, and any combinations thereof that include the body 105 and can receiving coatings on the substrate 110 of the body 105. In some embodiments, the installation device 100 can include, but not limited to, connectors, conductors, conduits, housings, receptacles, covers, plating, outlets, cabinets, other components, and any combinations thereof. In some embodiments, the installation device 100 can protect electrical components attached to, or located within the installation device 100, from dirt or debris, protect electrical components from damage, and prevent users from unintentionally coming into contact with live electrical components.

In some embodiments, the installation device 100 can include a floor box cover. The floor box cover can cover an electrical box located in, or adjacent to, a structural surface or an opening in the structural surface. In some embodiments, the installation device 100 can cover the opening in the structural surface. In some embodiments, the structural surface can include a floor, ceiling, wall, other surfaces, and any combinations thereof. In some embodiments, the installation device 100 can be removably connected to the electrical box by a screw, connector, clasps, other devices, and a combination thereof, to retain the installation device 100 over the electrical box and/or the opening of the structural surface.

In some embodiments, the installation device 100 can include the body 105. In some embodiments, the body 105 can include any of a plurality of shapes and profiles. In some embodiments, the body 105 can include any of a plurality of shapes to cover an electrical box installed into the structural surface. In some embodiments, the body 105 can include any of a plurality of profiles to cover the opening extending through the structural surface. In some embodiments, the profile of the body 105 can further include any of a plurality of shapes to cover, at least in part, the electrical box located on the structural surface, in the structural surface, adjacent to the structural surface, and any combinations thereof. Consequently, in some embodiments, the installation device 100 can be round, square, rectangular, oval, trapezoidal, other shapes, and any combination thereof. In some embodiments, the installation device 100 can include any of a plurality of dimensions (i.e., width, depth, and height) to cover the structural surface opening, to cover the electrical box, and combinations thereof. For example, the installation device 100 can include a square cover installed in a circular opening extending through a wood floor, the electrical box being installed beneath the wood floor at the opening.

In some embodiments, the body 105 can be made of any of a plurality of materials that can resist deformation caused by users, or other objects, coming into contact with the body 105. In some embodiments, the body 105 can be composed of, at least in part, a metallic material. In some embodiments, the metallic material can include brass, nickel, aluminum, copper, steel, stainless steel, iron, other alloys, and any combination thereof. In some embodiments, the body 105 can be composed of, at least in part, a polymer material. In some embodiments, the plastic material can include polypropylene, polycarbonate, polyethylene, polyterephthalate (PET), polyamide, thermoplastics, resins, other polymers, and any combination thereof. Further, the body 105 can be formed using any of a plurality of methods including, but not limited to, casting, die casting, CNC milling, CNC tuning, extrusion, pressing, injection molding, forging, thermosetting, stamping, welding, 3D printing, other methods, and any combination thereof.

The body 105 can include the first coating 120. The first coating 120 can improve the overall durability and protection provided to the installation device 100. In some embodiments, the first coating 120 can include a tint, or colorant. Consequently, in some embodiments, the first coating 120 can include a colored base coating. The first coating 120 can coat a surface of an object, such as the body 105, to form a layer over the surface of the object. In some embodiments, the first coating 120 can be tinted so that the first coating 120 can include any of a plurality of colors. Consequently, in some embodiments, when the first coating 120 is applied to a surface, the first coating 120 can, at least partially, conceal the substrate beneath the first coating 120. In some embodiments, the first coating 120 can be opaque, transparent, semi-transparent, and any combination thereof. In some embodiments, the first coating 120 can help level the surface of the substrate 110 for subsequent coating layers, promote adhesion of the first coating 120 to the substrate, promote adhesion of subsequent coating layers to the first coating 120, and any combination thereof.

In some embodiments, the first coating 120 can be a base coating. In some embodiments, the first coating 120 can include a tint to color the first coating 120. In some embodiments, the first coating 120 can be an automotive grade base coating. In some embodiments, a composition of the first coating 120 can include acrylic polyurethane. In some embodiments, the composition of the first coating 120 can include, but is not limited to, water, lacquer, urethane, polyurethane, ceramic, polymer, acrylic, latex, enamel, solvents, organic and inorganic pigments, binders, activators, other compounds, and any combination thereof. In some embodiments, the first coating 120 can include a base coating including a polyceramic compound to provide improved durability, hardness, and resistance to scuffs and abrasions. In some embodiments, the first coating 120 applied to the installation device 100 can be based, in part, on a predetermined hardness, durability, and any combination thereof.

In some embodiments, the first coating 120 can be applied directly onto the substrate 110 of the body 105. For example, the first coating 120 can be applied to the bare metal substrate of the installation device 100 made of brass. In some embodiments, the first coating 120 can be applied onto another coating composition that is applied to the body 105 before the first coating 120. In some embodiments, the first coating 120 can include a single layer of coating. In some embodiments, the first coating 120 can include a plurality of layers of the first coating 120, each previous layer of first coating 120 being applied and allowed to cure for a predetermined amount of time before a subsequent layer can be applied.

The body 105 can include the second coating 125. In some embodiments, the second coating 125 can be a clear coat sealant. The second coating 125 can encapsulate, seal, and protect the underlying coating layers and the substrate of the body 105. Further, the second coating 125 can protect the underlying materials by resisting scuffs, abrasions, and other similar damage. In some embodiments, the composition of the second coating 125 can include, but is not limited to, water, lacquer, urethane, polyurethane, ceramic, polymer, acrylic, latex, enamel, solvents, organic and inorganic pigments, binders, activators, other compounds, and any combination thereof.

In some embodiments, the second coating 125 can include an automotive grade clear coating. In some embodiments, the second coating 125 can include a polyceramic compound to improve hardness, durability, and resistance to scuffs and abrasions. In some embodiments, the second coating 125 applied to the installation device 100 can be based, in part, on a predetermined hardness, durability, and any combination thereof.

In some embodiments, each of the first coating 120 and the second coating 125 can include polyceramic compounds. In some embodiments, each of the first coating 120 and the second coating 125 can be resistant to scratches, gouges, and other damage. In some embodiments, the hardness of the first coating 120 and the second coating 125 can be determined based on a gouge hardness test, or a pencil test (ASTM D3363). In some embodiments, each of the first coating 120 and the second coating 125 can include a hardness of between 4 h to 8 h. In some embodiments, each of the first coating 120 and the second coating 125 can include a hardness of 8 h. In some embodiments, each of the first coating 120 and the second coating 125 can include a hardness of up to 9 h. In some embodiments, each of the first coating 120 and the second coating 125 can include a hardness of 9 h. In some embodiments, each of the first coating 120 and the second coating 125 can include a hardness of greater than 9 h. In some embodiments, each of the first coating 120 and the second coating 125 can include a hardness of up to 10 h.

In some embodiments, each of the first coating 120 and the second coating 125 can be resistant abrasions to resist damage to each of the first coating 120, the second coating 125, and any underlying material covered by each of the first coating 120 and the second coating 125 including the body 105. In some embodiments, the durability of a coating from abrasions can be determined using an abrader applying an abrasive force to the coating for a number of cycles. Consequently, the durability of the coating can be represented in wear cycles per mil. In some embodiments, each of the first coating 120 and the second coating 125 can include a taber abrasion rating of greater than 4000 wear cycles per mil. In some embodiments, each of the first coating 120 and the second coating 125 can include the taber abrasion rating of greater than 5000 cycles per mil. In some embodiments, each of the first coating 120 and the second coating 125 can include the taber abrasion rating of greater than 6000 cycles per mil. In some embodiments, each of the first coating 120 and the second coating 125 can include the taber abrasion rating of be greater than 7000 cycles per mil. In some embodiments, each of the first coating 120 and the second coating 125 can include the taber abrasion rating of up to 8000 cycles per mil. In some embodiments, the taber abrasion rating for each of the first coating 120 and the second coating 125 can range from 6000 to 8000 cycles per mil.

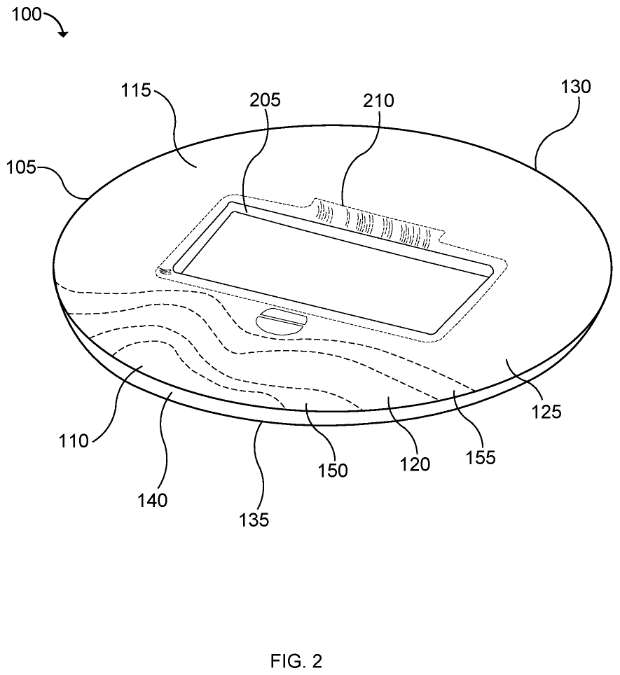

In some embodiments, the body 105 can include a first member 130. In some embodiments, the first member 130 can have a first shape and have a first size. In some embodiments, the first member 130 can be disposed at the proximal end of the body 105. In some embodiments, the first member 130 can cover the structural surface opening, the electrical box opening, and any combination thereof. In some embodiments, the first member 130 can include a first side 115, a second side 135, a third side 140, and at least one opening 205 (FIG. 2). The first side 115 can be located at the proximal end of the body 105. The second side 135 can be located towards the distal end of the first member 130 opposite the first side 115. In some embodiments, the second side 135 can abut the structural surface when the installation device 100 is positioned on the electrical box. In some embodiments, the second side 135 can abut the electrical box disposed beneath, or in, the structural surface. The third side 140 can define a circumference of the first member 130 and can axially extend from the first side 115 to the second side 135. In some embodiments, the third side 140 can perpendicularly extend from the first side 115 to the second side 135. In some embodiments, the third side 140 can angularly extend from the first side 115 to the second side 135 to provide an inclined edge from the first side 115 and the second side 135 to the other of the first side 115 and the second side 135. Further, the at least one opening 205 can be located on the first member 130 and axially extend through the first member 130, the body 105, and any combination thereof. In some embodiments, the at least one opening 205 can include any of a plurality of shapes to receive an electrical connector, electrical receptable, cord, cable, other devices, and any combination thereof. For example, the electrical box can include an electrical outlet receptacle and the installation device 100 can be installed onto the electrical box such that the electrical outlet receptable is accessible through the installation device 100 at the at least one opening 205.

In some embodiments, the installation device 100 can include a cover plate 145. The cover plate 145 can cover, at least in part, the at least one opening 205 of the body 105. In some embodiments, the cover plate 145 can be composed of the same material as the body 105. In some embodiments, the cover plate 145 can be composed of a different material than the body 105. In some embodiments, the cover plate 145 can be composed of, at least in part, a metallic material. In some embodiments, the metallic material can include brass, nickel, aluminum, copper, steel, stainless steel, iron, other alloys, and any combination thereof. In some embodiments, the cover plate 145 can be composed of, at least in part, a polymer material. In some embodiments, the polymer material can include polypropylene, polycarbonate, polyethylene, polyterephthalate (PET), polyimide, thermoplastics, resins, other polymers, and any combination thereof. Further, the cover plate 145 can be formed using any of a plurality of methods including, but not limited to, casting, die casting, CNC milling, CNC tuning, extrusion, pressing, injection molding, forging, thermosetting, stamping, welding, 3D printing, other methods, and any combination thereof.

In some embodiments, the body 105 can include a recessed segment 210 (FIG. 2) located on the first side 115 of the body 105. In some embodiments, the recessed segment 210 extends from the proximal end on the first side 115 towards the distal end of the body 105. In some embodiments, the cover plate 145 can include any of a plurality of sizes, shapes, and dimensions to cover the at least one opening 205. In some embodiments, the size, shape, and the dimensions of the cover plate 145 can correspond to the recessed segment 210 (FIG. 2) so that the cover plate 145 sits in the recessed segment 210 in a closed position. In some embodiments, the body 105 can include the first member 130 having a first size and the cover plate 145 can have a second size. In some embodiments, the first size and the second size can be the same size so the cover plate covers the first side 115 of the body 105. In some embodiments, the second size can be smaller than the first side 115 so the cover plate 145 covers a portion of the first side 115. In some embodiments, the cover plate 145 can include any of a plurality of shapes irrespective of the shape of the first side 115. In some embodiments, the shape of the cover plate 145 can be square, rectangular, circular, trapezoidal, other shapes, and any combination thereof. For example, the first side 115 of the body 105 can have a square shape and the cover plate 145 can be a circular shape and located on the first side 115. In some embodiments, the cover plate 145 can include at least one cutout to allow electrical connectors to extend through the cutout. In some embodiments, the at least one cutout can be located along a circumference of the cover plate 145. In other embodiments, the at least one cutout can be centrally disposed on the cover plate 145, thereby forming an aperture extending through the cover plate 145.

In some embodiments, the cover plate 145 can be attached to the body 105 and can be moved from a first position to a second position. The first position being a closed position and the second position being an open position. In some embodiments, the cover plate 145 can be moved into a plurality of other positions including the first position and the second position. In some embodiments, the cover plate 145 can include a connecting portion, the cover plate 145 being attached to the body 105 at the connecting portion. In some embodiments, the installation device 100 can further include a retaining member to attach the cover plate 145 to the body 105. In some embodiments, the retaining member can include a hinge, pins, rivets, springs, threads, slides, bearings, rollers, other components, and any combination thereof.

In some embodiments, the cover plate 145 can be hingeably attached to the body 105, the cover plate 145 hingeably moving from the first position to the second position to expose the recessed segment 210, the at least one opening 205, the electrical box, and any combination thereof. In some embodiments, the cover plate 145 can be rotatably connected to the body 105, the cover plate 145 rotatably moving from a first position to a third position and exposing the recessed segment 210, the at least one opening 205, and any combination thereof. In some embodiments, the cover plate 145 can include threads along an outer circumference of the cover plate 145 and the recessed segment 210 can include threads along the circumference of the recessed segment 210. Therefore, in some embodiments, the threads of the cover plate 145 can threadingly engage the threads of the recessed segment 210 to attach the cover plate 145 to the body 105. Consequently, to access the recessed segment 210, the at least one opening 205, the electrical box, and any combination thereof, the cover plate 145 can be removed from the body 105 by unscrewing the cover plate 145 from the body 105.

In some embodiments, the recessed segment 210 can further include a step and the cover plate 145 can be seated in the step to cover the recessed segment 210, the at least one opening 205, and any combination thereof. Consequently, in some embodiments, the cover plate 145 can be removed from the body 105 to access the recessed segment 210, the at least one opening 205, the electrical box, and any combination thereof.

In some embodiments, each of the first coating 120, the second coating 125, the third coating 150, and the fourth coating 155 can be applied to the cover plate 145. In some embodiments, each of the first coating 120, the second coating 125, the third coating 150, and the fourth coating 155 can be applied to the cover plate 145 at the same time as the body 105. In some embodiments, each of the first coating 120, the second coating 125, the third coating 150, and the fourth coating 155 can be applied to the cover plate 145 separately from the body 105, the cover plate 145 being attached to the body 105 after the cover plate 145 and the body 105 have each received each of the first coating 120, the second coating 125, the third coating 150, the fourth coating 155, and any combination thereof.

In some embodiments, the substrate 110 of the body 105 can be prepared before the coating can be applied to the body 105. The preparation of the surface can promote adhesion of the coating onto the substrate 110. In some embodiments, the preparation can include sanding the surface of the substrate 110. In some embodiments, the surface of the substrate 110 can be prepared using a plurality of preparation methods including, but not limited to, sanding, ultrasonic polishing, tumbling, magnetic polishing, sandblasting, lapping, filing, other methods, and any combination thereof. In some embodiments, the cover plate 145 and any other parts of the installation device 100 can receive a preparation prior to being coated.

In some embodiments, the surface of the substrate 110 can be pretreated before the coating can be applied to the body 105. Pretreatment can remove any dirt, debris, oil, and contaminants from the surface and help promote adhesion by imparting changes to a property of the surface. In some embodiments, pretreatment can include a chemical wash, a flame treatment, a corona treatment, other treatments, and any combination thereof. The installation device 100 can be pretreated before the preparation, after the preparation, or any combination thereof. For example, the installation device 100 can receive a chemical wash, then be sanded, then receive a second pretreatment including the chemical wash and the corona treatment. In some embodiments, the cover plate 145, and any other parts of the installation device 100 can be pretreated prior to being coated.

The chemical wash removes any dirt, debris, dust, oil, and other contaminants from the surface. Further, the object receiving the chemical wash can be rinsed with fresh water, or deionized water, to remove the chemical wash and any detergents, oil, and other contamination. The flame treatment is the application of a flame to a material's surface to improve adhesion for adhesives, ink, and other coatings. Flame treatment activates the surface receiving the coating by partial oxidation. By applying heat to the surface, the molecular chains can be broken and polar functional groups can be added. The flame can include a gas flame, or other types of flames, to create high temperature, oxygen rich plasma. Flame treatment can also remove contaminants from the material surface by burning off dust, fibers, oils, and other surface contaminants. The flame treatment can be applied to metals, alloys, thermoplastic olefins, polyolefins, polyethylene, polypropylene, other compounds, and combinations thereof. Corona treatment (air plasma) is a surface modification technique that uses low temperature corona discharge to impart changes in the properties of a surface, such as by increasing a material's surface tension, to promote adhesion of the material to adhesives, inks, and other coatings.

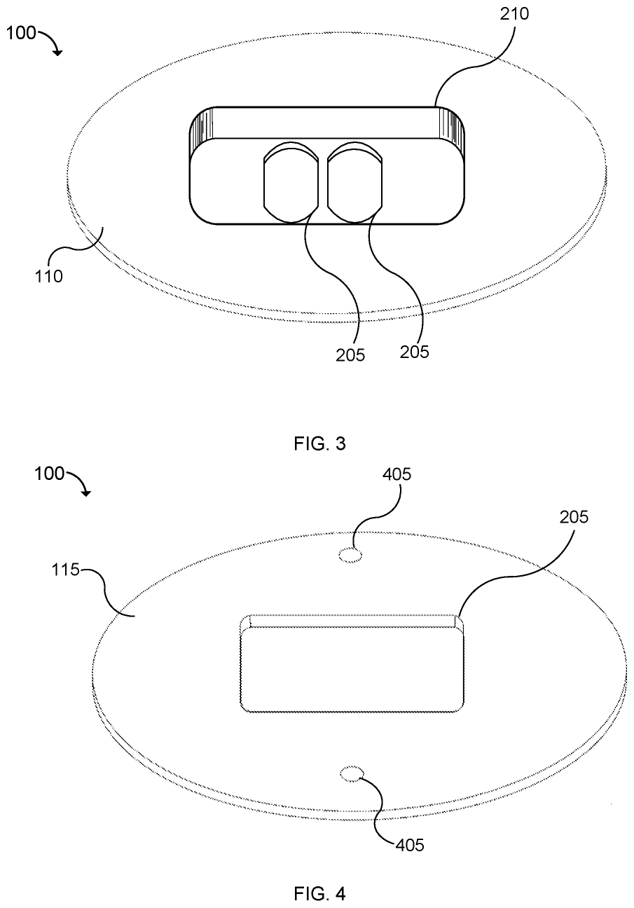

FIG. 2 is a perspective view of the installation device 100, according to some embodiments. FIG. 3 is a perspective view of the installation device 100, according to some embodiments.

Referring to FIG. 2, in some embodiments, the installation device 100 can include a third coating 150 and a fourth coating 155. In some embodiments, the third coating 150 can be a primer coating. In some embodiments, the third coating 150 can be located between the substrate 110 and the first coating 120. In some embodiments, the third coating 150 can be a primer coating and the first coating 120 can be a base coating. In some embodiments, the third coating 150 can be applied to the raw surface of the substrate 110. Consequently, the third coating 150 can improve adhesion of subsequent coatings to the body 105. In some embodiments, the third coating 150 can further level the surface for subsequent coatings. In some embodiments, the third coating 150 can include a tint, and the third coating 150 can be a colored primer coating. In some embodiments, the color of the third coating 150 can be based, in part, on the overall pattern or aesthetic of the installation device 100 once the coating layers have been applied to the body 105 and the coating layers on the body 105 have been sealed with a clear coat sealant.

In some embodiments, the third coating 150 can be applied to part of the substrate 110 of the body 105. In some embodiments, the third coating 150 can substantially cover the substrate 110 of the body 105. In some embodiments, the third coating 150 can be applied to the substrate 110 to encapsulate the substrate 110 of the body 105 to promote the first coating 120 adhering to the body 105 and the third coating 150.

In some embodiments, the third coating 150 can include a primer coating. In some embodiments, the third coating 150 can include an automotive grade coating. In some embodiments, the composition of the third coating 150 can include acrylic polyurethane. In some embodiments, the composition of the third coating 150 can include, but is not limited to, water, lacquer, urethane, polyurethane, ceramic, polymer, acrylic, latex, enamel, solvents, organic and inorganic pigments, binders, activators, other compounds, and any combination thereof.

In some embodiments, the third coating 150 can include a single layer of coating. In some embodiments, the third coating 150 can include a plurality of layers of coating. Each successive layer can be applied to the preceding surface once the surface is ready to receive a layer of the third coating 150. For example, a second layer of third coating 150 can be applied to the body 105 after the first layer has cured to a point so the second layer can be applied to the body 105.

In some embodiments, the fourth coating 155 can be a water transfer graphic applied to the body 105 by water transfer printing (i.e., hydro dipping). A water transfer graphic film is positioned onto the surface of a solution. The solution dissolves the film and the remaining graphic pattern floats on the surface of the solution. A member that is to receive the graphic is then submerged into the solution through the water transfer graphic so that the graphic transfers from the solution's surface to the desired surface of the member. The surface tension of the solution retains the graphic pattern and causes the graphic pattern to form onto the member surface and adhere to the member as it is immersed into the solution.

In some embodiments, the fourth coating 155 can include an activator solution applied to the water transfer film or the remaining graphic pattern floating on the solution surface. The activator solution can aid in dissolving the film. Further, the activator solution can cause the film to enter a fluid state to adhere to the surface of the member. In some embodiments, the activator solution can further cause a chemical reaction with the underlying layer of coating to soften the layer to allow ink from the graphic pattern to bond with the coating. In some embodiments, the fourth coating 155 can include a PVA hydrographic film.

In some embodiments, the fourth coating 155 can be located between the first coating 120 and the second coating 125. In some embodiments, the fourth coating 155 can include an opaque portion, a semi-transparent portion, a transparent portion, and any combination thereof. Consequently, in some embodiments, the underlying layer can be viewed through the semi-transparent portion or the transparent portion of the third coating 150. For example, the fourth coating 155 can be a wood grain graphic pattern and the first coating 120 can be a base coating with the color of a particular wood species. When the fourth coating 155 is applied onto the first coating 120, the color of the first coating 120 and the graphic pattern of the fourth coating 155 can simulate the particular wood species, or simulate the color of the wood species with a particular colored stain.

In some embodiments, the fourth coating 155 can include a single layer. In some embodiments, the fourth coating 155 can include a plurality of layers that form the graphic pattern. The plurality of layers combining to form the graphic pattern. In some embodiments, the fourth coating 155 can include a plurality of water transfer graphic patterns. For example, the fourth coating 155 can be a first water transfer graphic and a second water transfer graphic, the combination of the first water transfer graphic and the second water transfer graphic providing the desired graphical representation.

Further, in some embodiments, the fourth coating 155 can include any of a plurality of patterns. In some embodiments, the fourth coating 155 can include a wood grain pattern, a stained wood pattern, other wood patterns, and any combination thereof. In some embodiments, the fourth coating 155 can include a pattern of a structural surface including wood, concrete, tile, polyvinyl laminate, metals, other surfaces and combinations thereof. In some embodiments, the fourth coating 155 can include a single color or a plurality of colors. In some embodiments, each of the first coating 120 and the fourth coating 155 can contribute to the graphical representation of the installation device 100.

In some embodiments, the fourth coating 155 can be applied to the body 105. In some embodiments, the fourth coating 155 can be applied to the body 105, the underlying coating layers, and portions thereof. For example, the first coating 120 and the third coating 150 can be applied to the surfaces of the body 105, while the fourth coating 155 can be applied to the first side 115 of the first member 130 so the first side 115 includes the graphical pattern on the body. Further, the second coating 125 can be applied to the surfaces of the body 105 to encapsulate the body 105, the third coating 150, the first coating 120, and the fourth coating 155.

In some embodiments, the installation device 100 can include each of the first coating 120, the second coating 125, third coating 150, and the fourth coating 155. In some embodiments, the third coating 150 can be first applied to the raw surface of the body 105 to coat at least a portion of the substrate. Further, in some embodiments, the first coating 120 can be applied onto the third coating 150. In some embodiments, the fourth coating 155 can be applied onto the first coating 120. Further, in some embodiments, the second coating 125 can be applied to the fourth coating 155 to seal the underlying coatings, the body 105, and any combination thereof. In some embodiments, each of the first coating 120, the second coating 125, the third coating 150, and the fourth coating 155 can include a single layer of coating, multiple layers of coating, and any combination thereof, applied to the body 105.

In some embodiments, the body 105 can include a recessed segment 210. In some embodiments, the recessed segment 210 can be disposed on the first side 115 of the body 105 at the proximal end and extend towards the distal end, thereby forming a recessed area on the surface of the first side 115. In some embodiments, the recessed segment 210 can include a plurality of shapes, sizes, dimensions, and any combination thereof. In some embodiments, the size and depth of the recessed segment 210 can be based on, at least in part, the cover plate 145, the at least one opening 205, the components in the electrical box, an external device connector connected to the electrical box, and any combination thereof. In some embodiments, the recessed segment 210 can include a first recessed segment 210′ and a second recessed segment 210″. In some embodiments, the first recessed segment 210′ can extend from the proximal end towards the distal end a first distance and the second recessed segment 210″ can extend from the proximal end towards the distal end a second distance, the first recessed segment 210′ forming a step the cover plate 145 can rest on. Further, in some embodiments, the at least one opening 205 can be located at the distal end of the second recessed segment 210″.

In some embodiments, the at least one opening 205 can be disposed in the recessed segment 210. In some embodiments, the at least one opening 205 can include a plurality of sizes, shapes, dimensions, and any combination thereof to receive an electrical device connected to the electrical box or to allow the connector of an external electrical device to connect to the electrical components in the electrical box. In some embodiments, the at least one opening 205 can be the shape of an outlet receptacle. In some embodiments, the at least one opening 205 can be circular, oval, square, rectangular, trapezoidal, other shapes, and any combination thereof. For example, the at least one opening 205 can include a single opening to allow an electrical outlet receptacle to at least partially extend through the at least one opening 205. In some embodiments, the at least one opening 205 can include a first opening and a second opening to allow an electrical connector near the proximal end to connect to an electrical outlet receptacle disposed at or near the distal end.

In some embodiments, the body 105 can include at least the first member 130. Further, in some embodiments, the cover plate 145 can be located at the first side 115 of the first member 130. In some embodiments, the cover plate 145 can receive each of the first coating 120, the second coating 125, the third coating 150, and the fourth coating 155. In some embodiments, the at least the first member 130 and the cover plate 145 can receive each coating at the same time. in some embodiments, each coating can be separately applied to each of the at least the first member 130 and the cover plate 145.

FIG. 4 is a perspective view of the installation device 100, according to some embodiments. In some embodiments, the body 105 can include an at least one aperture 405 extending through the body 105 from the first side 115 to the second side 135. In some embodiments, the at least one aperture 405 can include a single aperture 305. In some embodiments, the at least one aperture 405 can include a first aperture 305′ disposed at a first end of the first side 115 and a second aperture 305″ disposed at a second end opposite the first aperture 305 on the first side. In some embodiments, the first aperture 305 and the second aperture 305 can be disposed on opposite sides of the at least one opening 205. The at least one aperture 405 can receive a connector to connect to the electrical box, the structural member, some other member, and any combination thereof. In some embodiments, the at least one aperture 405 can be threaded. In some embodiments, the installation device 100 can further include a connector connected to the body 105 using a retaining member. In some embodiments, the retaining member can include a clamp, nut, washer, other retaining member, and any combination thereof.

FIG. 5 is a bottom perspective view of the installation device 100, according to some embodiments. In some embodiments, the body 105 can include a plurality of members that form the body 105. In some embodiments, the body 105 can include the first member 130 and a second member 505. In some embodiments, the second member 505 can be attached to the first member 130 at the second side 135. In some embodiments, the shape of the second member 505 can be based, at least in part, on the electrical box, the structural surface opening, and any combination thereof. For example, the dimensions of the second member 505 can be the same dimensions as the proximal end of the electrical box. In another example, the structural surface opening can be determined based on the dimensions of the second member 505. Thus, in some embodiments, the structural surface opening can be determined by a template including the same dimensions as the second member 505.

In some embodiments, the second member 505 can include a shape defined by at least one side wall. The at least one side wall can extend from the second side 135 of the first member 130 to the distal end of the body 105. In some embodiments, the at least one side wall can be located around the at least one opening 205 to allow an electrical connector to connect to a component located in the electrical box.

In some embodiments, each of the first member 130 and the second member 505 can receive the coatings. In some embodiments, the coatings can be applied to the first member 130. In some embodiments, the coatings can be applied to the first member 130 and at least a portion of the second member 505. In some embodiments, the coatings can include the first coating 120 and the second coating 125. In some embodiments, the coatings can include the first coating 120, the second coating 125, the third coating 150, and the fourth coating 155.

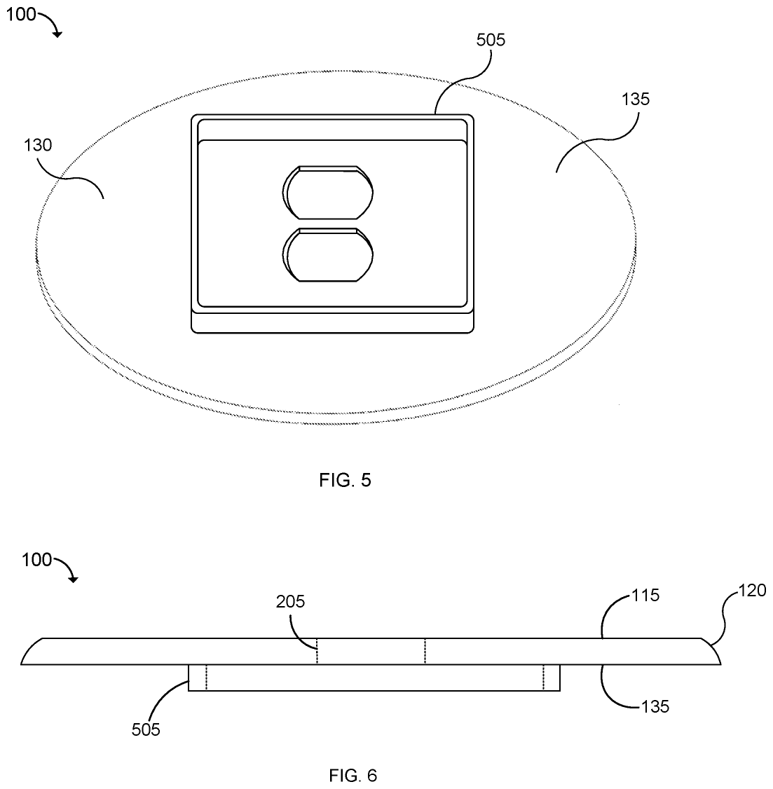

FIG. 6 is a side view of the installation device 100, according to some embodiments. In some embodiments, the first member 130 can be positioned on the structural surface. In some embodiments, the second member 505 can extend through the structural surface opening towards the electrical box. In some embodiments, the second member 505 can help retain the installation device 100 in the structural surface opening. In some embodiments, the second member 505 can be connected to the electrical box. In some embodiments, the second member 505 can include other members to connect the body 105 to the electrical box, an electrical device connected to the electrical box, the structural surface, a structural member, and any combination thereof.

In some embodiments, the third side 140 can include a plurality of profiles. In some embodiments, the third side 140 can be straight, rounded, convex, concave, other profiles, and any combination thereof.

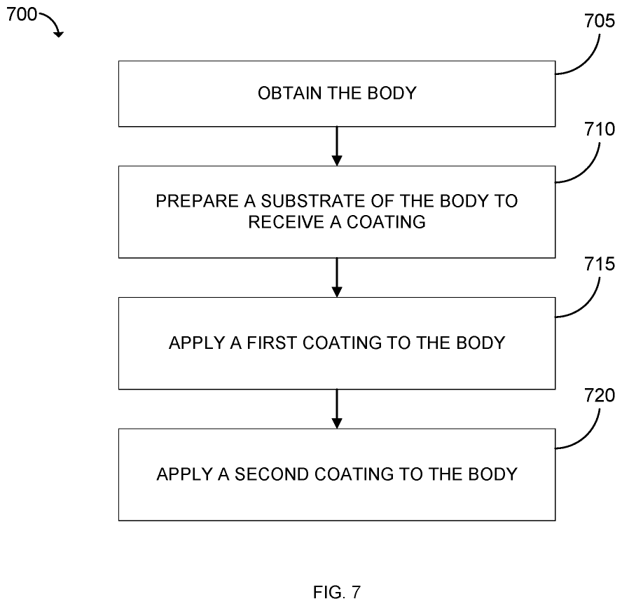

FIG. 7 is a flowchart of a method 700, according to some embodiments. The method 700 generally relates to applying successive coatings onto the installation device 100. In some embodiments, the installation device 100 can include a body 105 including a substrate 110 and including a first side 115 and a second side 135. At 705, the method 700 includes obtaining the body 105. In some embodiments, the body 105 can include a first member 130 and a second member 505. In some embodiments, the installation device 100 can include the cover plate 145. In some embodiments, the cover plate 145 can be attachably connected to the first side 115 of the body 105. In some embodiments, the cover plate 145 can be attached to the body 105 near the at least one opening 205, the cover plate 145 covering the at least one opening 205 when in the first position and allowing an electrical connector to access the at least one opening 205 when the cover plate 145 is in the second position.

In some embodiments, the body 105 can further include a recessed segment 210. In some embodiments the body 105 can include a cover plate 145 located at the recessed segment so the cover plate 145 sits flush with the first side 115. In some embodiments, the cover plate 145 can be located at the recessed segment 210. In some embodiments, the cover plate 145 can be attached to the first side 115 of the body 105. Further, in some embodiments, the cover plate 145 can be hingeably connected to the first side 115 of the body 105. In some embodiments, the cover plate 145 can be rotatably attached to the first side 115 of the body 105. In some embodiments, the cover plate 145 can be positioned at the at least one opening 205 and can be removed from the body 105 to expose the at least one opening 205 to access the electrical box and any components located within the electrical box. In some embodiments, the first coating 120 and the second coating 125 can further be applied to the cover plate 145. In some embodiments, the first coating 120, the second coating 125, the third coating 150 and the fourth coating 155 can be applied to the cover plate 145 similar to the body 105. In some embodiments, each of the first coating 120, the second coating 125, the third coating 150, and the fourth coating 155 can be applied to the cover plate 145 at the same time as the body 105.

At 710, the method 700 includes preparing a substrate 110 of the body 105 to receive a coating. In some embodiments, preparing the substrate 110 can improve adhesion of the coating to the substrate 110. In some embodiments, preparing the substrate 110 can include sanding, ultrasonic polishing, tumbling, magnetic polishing, sandblasting, lapping, filing, other methods, and any combination thereof. In some embodiments, preparing the substrate 110 can include pretreating the substrate 110. In some embodiments, pretreating the substrate 110 can include a chemical wash, a flame treatment, a corona treatment, other treatments, and any combination thereof applied to the substrate before applying the coating.

In some embodiments, a portion of the body 105 can be prepared to receive a coating. In some embodiments, the first side 115 of the body 105 can be prepared to receive the coating. In some embodiments, the first side 115 and the second side 135 can be prepared to receive the coating. In some embodiments, the first side 115 and the third side 140 can be prepared to receive the coating. In some embodiments, the whole substrate 110 of the body 105 can be prepared to receive the coatings.

At 715, the method 700 includes applying a first coating 120 to the body 105. In some embodiments, the first coating 120 can include a base coating material. In some embodiments, the base coating material can be an automotive grade base coating. In some embodiments, the base coating material can further include a polyceramic compound. The polyceramic compound can protect the base coating and the underlying substrate(s) by resisting damage from impacts, scrapes, abrasions, scuffs, and other damage. In some embodiments, the first coating 120 can include tint(s). Therefore, in some embodiments, the first coating 120 can include a colored coating including any of a plurality of colors.

In some embodiments, the first coating 120 can be applied directly to the raw surface of the body 105. In some embodiments, the first coating 120 can be applied to another coating layer. For example, the first coating 120 can be applied to a primer coating. In some embodiments, the first coating 120 can be applied to a first side 115 of the body. In some embodiments, the first coating 120 can be applied to the first side 115 and the third side 140 of the body 105. In some embodiments, the first coating 120 can be applied to the first side 115, third side 140, and the second side 135. In some embodiments, the first coating 120 can be applied to substantially the whole substrate of the body 105 to encapsulate the substrate 110. In some embodiments, the first coating 120 can be applied to a portion of the substrate 110. In some embodiments, the coatings applied to the body 105 can be based, in part, on the surfaces of the body 105 likely to be susceptible to damage, the surfaces where a water transfer graphic will be applied to the body 105, other considerations, and any combination thereof. For example, the first coating 120 can be applied to a first member 130 but not a second member 505 of the body.

In some embodiments, applying the first coating 120 to the body 105 can include applying a single layer of first coating 120. In some embodiments, applying the first coating 120 can include applying a plurality of coatings to the body 105. In some embodiments, each layer of first coating 120 can be applied after sufficient time for curing of the previous layer has elapsed. In some embodiments, each layer successive layer of first coating 120 can be applied after the previous layer has cured.

At 720, the method 700 includes applying a second coating 125 to the body 105. In some embodiments, the second coating 125 can include a clear coat material. In some embodiments, the second coating 125 can include a clear coat sealant. In some embodiments, the clear coat sealant can be an automotive grade clear coat sealant. In some embodiments, the second coating 125 can include a polyceramic compound in the clear coat sealant. The polyceramic clear coat sealant can protect the second coating 125 and the underlying substrate(s) by resisting damage from impacts, scrapes, abrasions, scuffs, and other damage.

In some embodiments, the second coating 125 can be applied to the first coating 120. In some embodiments, the second coating 125 can be applied to a fourth coating 155 as will be further described below. In some embodiments, the second coating 125 can cover the first coating 120, the substrate 110 of the body 105, part of the first coating 120 and the substrate 110, and any combination thereof. In some embodiments, the second coating 125 can cover the first coating 120, the third coating 150, the fourth coating 155, the substrate 110, and any combination thereof. In some embodiments, the first coating 120 and the second coating 125 can cover at least a portion of the substrate 110. In some embodiments, the first coating 120 can include being located between the substrate 110 and the second coating 125.

In some embodiments, applying the second coating 125 to the body 105 can include applying a single layer of second coating 125. In some embodiments, applying the second coating 125 can include applying a plurality of coatings to the body 105. In some embodiments, each layer of second coating 125 can be applied after sufficient time for curing of the previous layer has elapsed. In some embodiments, each layer successive layer of second coating 125 can be applied after the previous layer has cured.

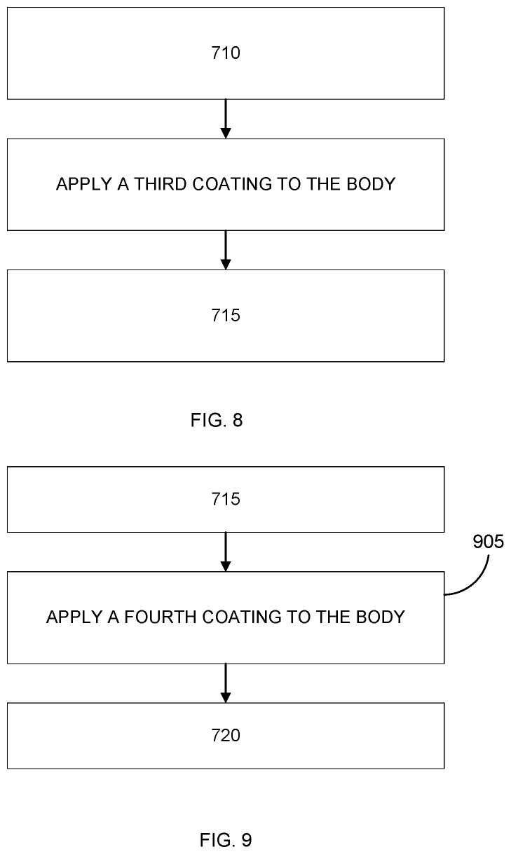

FIG. 8 is a flowchart of a method 700, according to some embodiments. In some embodiments, the method 700 can proceed from 710 to 805. In some embodiments, at 805, the method 700 can include applying a third coating 150 to the body 105. In some embodiments, the third coating 150 can include a primer coating material. In some embodiments, the third coating 150 can be an automotive grade primer coating. In some embodiments, the third coating 150 can include tints so that the third coating 150 can include a color.

In some embodiments, the third coating 150 can be applied directly to the raw surface of the body 105. In some embodiments, the third coating 150 can be applied to a first side 115 of the body. In some embodiments, the third coating 150 can be applied to each of the first side 115 and the second side 135. In some embodiments, the third coating 150 can be applied to substantially the whole substrate of the body 105 to encapsulate the body 105 substrate. In some embodiments, the third coating 150 can be applied to a portion of the body 105. In some embodiments, the coatings applied to the body 105 can be based, in part, on the surfaces of the body 105 likely to be susceptible to damage, the surfaces where a water transfer graphic will be applied to the body 105, other considerations, and any combination thereof. For example, the third coating 150 can be applied to a first member 130 but not a second member 505 of the body. In some embodiments, the third coating 150 can be located between the substrate 110 and the first coating 120. In some embodiments, the method 700 can include proceeding from 805 to 715 of FIG. 7.

In some embodiments, applying the third coating 150 to the body 105 can include applying a single layer of third coating 150. In some embodiments, applying the third coating 150 can include applying a plurality of coatings to the body 105. In some embodiments, each layer of third coating 150 can be applied after sufficient time for curing of the previous layer has elapsed. In some embodiments, each layer successive layer of third coating 150 can be applied after the previous layer has cured.

FIG. 9 is a flowchart of a method 700, according to some embodiments. In some embodiments, the method 700 can proceed from 715 to 905. In some embodiments, the method 700 can further proceed from 715 to 810. In some embodiments, at 810, the method 700 can include applying a fourth coating 155 to the body 105. In some embodiments, the fourth coating 155 can be a water transfer graphic. In some embodiments, the fourth coating 155 can be applied to the body 105 by hydro dipping the body 105, or at least a portion of the body 105 that will receive the graphic pattern. The pattern is applied to the body 105 by submerging the portion of the body 105 receiving the pattern into a solution. The solution including a graphic pattern film located on a surface of the solution. In some embodiments, applying the fourth coating 155 can further include applying an activator solution to the water transfer graphic film, the body 105, and any combination thereof. The activator solution can help dissolve the film of the water transfer graphic film so the graphic pattern remains on the surface of the solution. Further, in some embodiments, the activator solution can help promote adherence of the graphic pattern onto the body 105 by softening the layer of coating the graphic pattern will be adhering to. In some embodiments, the fourth coating 155 can include a polyvinyl alcohol (PVA) hydrographic film applied using water transfer printing.

In some embodiments, applying the fourth coating 155 to the body 105 can include applying a single water transfer graphic pattern to the body 105. In some embodiments, applying the fourth coating 155 can include applying a plurality of water transfer graphic patterns onto the body 105. In some embodiments, each successive water transfer graphic pattern applied to the body 105 can be after the previous graphic pattern has cured. Consequently, in some embodiments, the fourth coating 155 can include a multi-layer water transfer graphic pattern.

In some embodiments, the fourth coating 155 can be applied to the first coating 120. In some embodiments, the fourth coating 155 can be located between the first coating 120 and the second coating 125. In some embodiments, the fourth coating 155 can be applied onto part of the first coating 120 covering the substrate 110 of the body 105. In some embodiments, the fourth coating 155 can be applied to the first side 115 of the body 105.

In some embodiments, portions of the fourth coating 155 can be opaque, transparent, semi-transparent, and any combination thereof. Consequently, in some embodiments, the fourth coating 155 can include transparent and semi-transparent portions. Further, in some embodiments, an underlying coating or substrate can be observed through the fourth coating 155 after the fourth coating 155 is applied to the body 105. In some embodiments, the method 700 can include proceeding from 905 to 720 of FIG. 7.

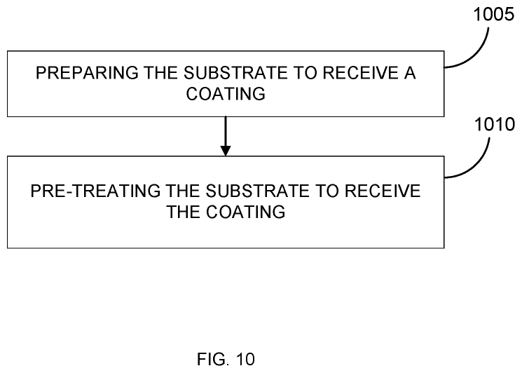

FIG. 10 is a flowchart of the method 700, according to some embodiments. In some embodiments, at 1005, the method 700 can include preparing the substrate 110 to receive a coating. In some embodiments, preparation can include a sanding of the surface of the substrate 110. In some embodiments, at 1010, the method 700 can include pre-treating the substrate to receiving the coating. In some embodiments, the pre-treatment can include a chemical wash, a flame treatment, a corona treatment, and any combination thereof. In some embodiments, the surface of the substrate 110 can be prepared to receive a coating. The sanding can help promote adhesion of the coatings to the surface of the substrate 110. In some embodiments, the pre-treatment can be applied to the installation device 100 before the preparation, after the preparation, and any combination thereof.

What is claimed is:

1. An installation device, comprising:
a body comprising a proximal end and a distal end,
a first coating,
wherein the first coating comprises a tinted coating; and
a second coating;
wherein the second coating comprises a clear coat sealant;
wherein the device comprises a substrate having a surface;
wherein the first coating and the second coating coat at least part of the substrate;
wherein the first coating comprises being disposed between the substrate and the second coating.

2. The installation device of claim 1, wherein each of the first coating and the second coating further comprises a polyceramic coating.

3. The installation device of claim 1, wherein the device further comprises:
a third coating,
wherein the third coating comprises a primer coating disposed between the substrate and the first coating;
wherein the first coating further comprises a base coating disposed between the second coating and the third coating.

4. The installation device of claim 1, wherein the device further comprises:
a fourth coating,
wherein the fourth coating comprises a graphic pattern disposed between the first coating and the second coating,
wherein the first coating can be at least partially observed through a portion of the fourth coating.

5. The installation device of claim 4, wherein the fourth coating further comprises a PVA hydrographic film applied using water transfer printing.

6. The installation device of claim 1, wherein the body further comprises:
a first member disposed at the proximal end, the first member comprising:
a first side disposed at the proximal end,
a second side disposed opposite the first end towards the distal end,
a third side defining a circumference and axially extending from the first side to the second side, and
at least one opening axially extending through the first member from the first side to the second side.

7. The installation device of claim 6, further comprising:
a cover plate;
wherein the first member further comprises a recessed segment disposed on the first side and axially extending towards the distal end;
wherein the at least one opening further comprises being disposed at the recessed segment;
wherein the cover plate comprises being disposed at the recessed segment and the cover plate covers, at least in part, the recessed segment and the at least one opening.

8. The installation device of claim 1, wherein the installation device receives a preparation prior to being coated,
wherein the preparation comprises sanding the surface of the substrate.

9. The installation device of claim 1, wherein the installation device receives a pretreatment prior to being coated,
wherein the pretreatment comprises the surface of the substrate receiving a chemical wash, a flame treatment, a corona treatment, and a combination thereof.

10. A method for coating an installation device, the installation device comprising a body and having a proximal end and a distal end, the body comprising a substrate, the method comprising:
applying, to the installation device, a first coating; and
applying, to the installation device, a second coating;
wherein the first coating comprises a colored coating;
wherein the second coating comprises a clear coat sealant;
wherein the first coating and the second coating covers at least a portion of the substrate;
wherein the first coating comprises being disposed between the substrate and the second coating.

11. The method of claim 10, further comprising:
applying, to the installation device, a third coating;
wherein the third coating comprises a primer coating disposed between the substrate and the first coating applied to a raw surface of the substrate.

12. The method of claim 10, further comprising:
applying, to the installation device, a fourth coating;
wherein the fourth coating comprises a graphic disposed between the first coating and the second coating;
wherein the first coating can be at least partially observed through a portion of the fourth coating.

13. The method of claim 12, wherein the fourth coating further comprises a PVA hydrographic film applied using water transfer printing.

14. The method of claim 10, wherein the installation device further comprises a cover plate, and wherein the body further comprises:
a recessed segment disposed on the body at the proximal end, and
at least one opening extend through the body from the proximal end to the distal end,
wherein the cover plate comprises being disposed on the proximal end of the body at the recessed segment to cover, at least in part, the at least one opening.

15. The method of claim 10, further comprising:
preparing the substrate to receive a coating,
wherein preparing the substrate comprises sanding a surface of the substrate; and
pre-treating the substrate to receive the coating,
wherein pre-treating the substrate comprises a chemical wash, a flame treatment, a corona treatment, and any combination thereof.

16. A cover apparatus, comprising:
a body, the body comprising:
a substrate defining the body and comprising a surface,
a first side,
a second side,
a third side extending from the first side to the second side,
at least one opening extending from the first side to the second side,
at least one aperture extending from the first side to the second side;
at least one layer of first coating,
wherein the at least one layer of first coating comprises a tinted base coating; and
at least one layer of second coating,
wherein the at least one layer of second coating comprises a clear coat sealant;
wherein the at least one layer of first coating comprises being disposed between the substrate and the at least one layer of second coating;
wherein the at least one aperture can receive a connector to connect the cover apparatus to an electrical box.

17. The cover apparatus of claim 16, wherein the at least one first coating further comprises a polyceramic base coating.

18. The cover apparatus of claim 16, wherein the second coating comprises a polyceramic clear coat sealant.

19. The cover apparatus of claim 16, further comprising:
at least one layer of third coating,
wherein the at least one layer of third coating comprises a primer coating,
wherein the at least one layer of third coating comprises being disposed between the substrate and the at least one layer of first coating; and
at least one layer of fourth coating,
wherein the at least one layer of fourth coating comprises a water transfer graphic,
wherein the at least one layer of fourth coating comprises being disposed between the at least one layer of first coating and the at least one layer of second coating.

20. The cover apparatus of claim 16, further comprising:
a cover plate;
wherein the body further comprises a recessed segment disposed on the first side and extending towards the second side;
wherein the at least one opening comprises being disposed in the recessed segment;
wherein the cover plate comprises being disposed at the recessed segment to cover, at least in part, the recessed segment and the at least one opening.
